(19) United States
(12) Patent Application Publication
(10) Pub. No.: US 2024/0320485 A1
(43) Pub. Date: Sep. 26, 2024

(54) A METHOD FOR THE MODEL-INDEPENDENT SOLUTION OF INVERSE PROBLEMS WITH DEEP LEARNING IN IMAGE/VIDEO PROCESSING

(71) Applicant: Istanbul Medipol Universitesi Teknoloji Transfer Ofisi Anonim Sirketi, Beykoz, Istanbul (TR)

(72) Inventors: Hasan Fehmi ATES, Beykoz, Istanbul (TR); Bahadir Kürsat GÜNTÜRK, Beykoz, Istanbul (TR)

(21) Appl. No.: 18/259,406

(22) PCT Filed: Dec. 24, 2021
(86) PCT No.: PCT/TR2021/051503

§ 371 Date: Jun. 27, 2023

(30) Foreign Application Priority Data
Dec. 30, 2020 (TR) 2020/22517

(51) Int. Cl. G06N 3/08; G06T 11/00

(52) U.S. Cl. CPC G06N 3/08; G06T 11/00

(57) ABSTRACT

Disclosed is a method for the model-independent solution of inverse problems with deep learning in image/video processing.

### TECHNICAL FIELD

The invention is related to a method for the model-independent solution of inverse problems with deep learning in image/video processing.

### PRIOR ART

In the known state of the art, developing a general deep learning approach which can be used in the solution of different inverse problems in image and video processing has been an increasingly studied area of research. Such an architecture should be trained independently from the problem and easily adapted to the desired problem. Therefore, both the type of the blur model (motion, focus, Gaussian blur, etc.) and parameter values, and the noise type and level should be learned by the deep architecture and applied to the solution of the inverse problem. In the literature, it is observed that deep learning solutions independent from the physical model are developed in non-blind cases (where the model is known). Meinhardt et al. (2017) notes that the regularization step in conventional iterative methods coincides with the proximal (projection) operator of the regularization function (Venkatakrishnan vd., 2013). Therefore, instead of this projection process, use of a general denoising deep network is proposed. Using a deep network for regularization renders abiding by a specific regularization model unnecessary and enables the use of the same denoising deep network for the solution of different inverse problems. Meinhardt et al. (2017) used the general deep architecture they trained with Gaussian noise as the projection operator on the PDHG (primal-dual hybrid gradient) iterative optimization algorithm, and obtained results that are similar to the performance of the best deep architectures trained specially for different inverse problems. Also, it has been shown in this study that the deep architecture trained for a particular noise level can be easily adapted to different noise levels. Several articles investigate the use of deep architectures as proximal operator in optimization methods (Zhang et al., 2017-2; Chang et al., 2017; Wei et al., 2017; Lunz et al., 2018). While Zhang et al. (2017-2) use the denoising deep network in the HQS (Half Quadratic Splitting) method, Chang et al. (2017) preferred the ADMM (Alternating Direction Method of Multipliers) method. Wei et al. (2017) suggested the use of two different deep networks for both the projection and the reconstruction process this time, again for ADMM. In addition, the reconstruction (i.e. matrix inversion) process can be learned independent of the data. Thereby, by using deep networks in iterative optimization, both the process speed is increased and the projection operation that matches the learned probability distribution of the data can be performed independently of the regularization model. Similarly, Fan et al. (2017), in the architecture they named InverseNet, learn both the inverse of the physical model and the regularization operator by using two different deep networks. The difference of this study lies in producing the result on a single run without using iterative optimization and adapting the entire architecture for the problem desired to be solved by training end-to-end. Therefore, it cannot be said that the resulting architecture is independent from the inverse problem. In the approaches proposed in the literature, success was achieved in the solution of different inverse problems with a general deep architecture; however, its application to inverse problems where the blur model is variable or unknown (blind) was not mentioned. The closest study is the deep learning architecture created for blind deconvolution by Schuler et al. (2016). However, in this article that suggests an iterative and multi-scale structure, the convolutional network layers are only used for feature extraction, and for kernel estimation and reconstruction, standard methods that do not require learning are used. Therefore, even though the suggested architecture is end-to-end trainable, learning of the blur and regularization model by the deep network was not considered.

### BRIEF DESCRIPTION OF THE INVENTION

The subject invention is related to a method for the model-independent solution of inverse problems with deep learning in image/video processing, in order to eliminate the above-mentioned disadvantages and bring new advantages to the related field. With this invention, an end-to-end trainable deep learning-based solution for the solution of blind inverse problems was developed in order to overcome the shortcomings of the literature. Inverse problems are: blur (motion, focus blur, etc.) removal, denoising, single image/video super-resolution.

The invention provides a general deep learning method which is not dependent on the physical model of the problem for the solution of different inverse problems in image/video processing. The developed deep architecture is almost independent of the model parameters and can be adapted to different problems easily. The subcomponents of the model include separate deep architectures coinciding with each one of the model estimation, reconstruction and regularization steps in conventional iterative optimization methods. These architectures are trained end-to-end, in interaction with each other. In this invention, the most important originality lies in the development of a general and modular deep network architecture that does not require a problem-specific design and that can be easily adapted to the desired problem. In relation to its easy adaptability; in order to adapt the deep architecture to the problem in question, it is sufficient to fine tune the model parameters by applying a short period of training with the transfer learning method on a data set belonging to the particular problem. The developed method meets the need for a general solution to the blind deblurring, single image and video super-resolution problems. A general deep learning architecture that can be used for the solution of blind inverse problems was developed.

The unique aspects of the invention are as follows;
Solution of different inverse problems with a single general deep learning method is possible. To achieve this, quickly fine-tuning the model with a suitable training data set is sufficient.
A method that can be used in spatially varying deblurring problems was developed.
It is possible to apply image super-resolutions at different scales with a single model.
The developed method can be applied to video super-resolution.

The subject invention can be used as a method in an image/video processing software on a computer or an embedded hardware.

### BRIEF DESCRIPTION OF THE DRAWINGS

The figures and description of these FIGURES for the better understanding of the invention are as follows.

FIG. 1 General network architecture for inverse problems

### REFERENCE NUMBERS

The elements and description of these elements for the better understanding of the invention are as follows.
y: input image
\tilde{x}: estimated output image
K: General deep network architecture
D: Deep network performing the reconstruction
Q: Deep network estimating the distortion model
P: Deep network performing the regularization.
A: Distortion model
z: intermediate output image before regularization
u: Regularization parameters

### DETAILED DESCRIPTION OF THE INVENTION

In this detailed description, the novelty of the invention is described with examples only for the better understanding of the subject in the way that does not create any limiting effect.

Said invention is related to a method for the model-independent solution of inverse problems with deep learning in image/video processing.

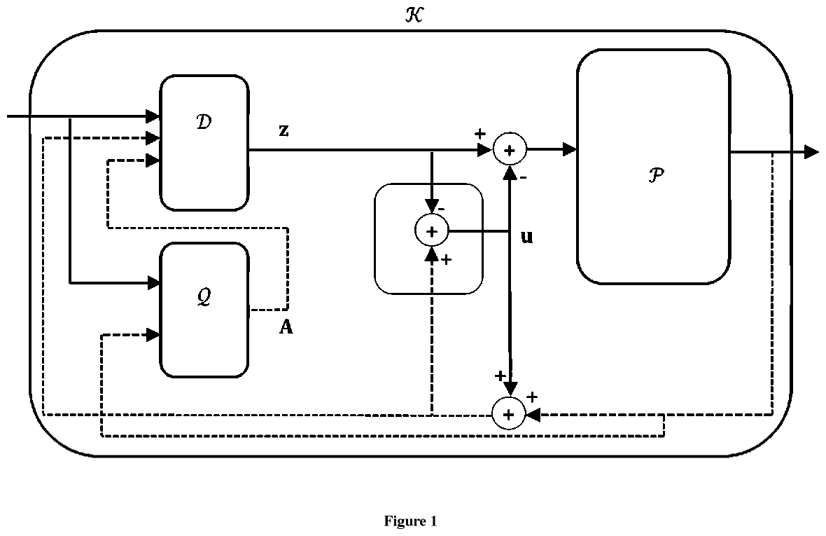

Some of the definitions related to the elements in FIG. 1;
y: input image (the image whose resolution and/or image quality is desired to be improved)
\tilde{x}: estimated output image (the image with an improved resolution and/or image quality as the model output)
K: The general deep network architecture designed for blind inverse problems (works iteratively. At the end of the number of iterations determined by the user, produces the estimated output image).
D: Deep network performing the reconstruction. Performs the reconstruction for the next iteration by using the input image, distortion model estimate and output image estimate. Creates the intermediate noisy output image (z) before regularization.
Q: Deep network estimating the distortion model. Updates the distortion model estimate for the next iteration by using the input image and estimated output image.
P: Deep network performing the regularization. Uses the intermediate noisy output image as input and updates the estimated output image.
A: Distortion model (includes distortion type, distortion parameters and estimated parameters related to noise).
z: The intermediate output image before regularization (contains the noise and artefacts that need to be eliminated with regularization)
u: The regularization parameters (optimization parameters controlling the iterative optimization/regularization steps).

The invention aims to offer solutions independent of the problem model and parameters for application in the solution of the problems. More clearly, a general deep network architecture was developed and trained, which can be used successfully in all problems such as blinddeblurring, single image/video super-resolution, etc. This architecture has three components:
A deep network architecture trained with adversarial learning techniques, learning the probability distribution of natural images in order to regularize the inverse problem solution. This deep neural network has been designed by benefiting from the convolutional network architectures frequently used as Generative Adversarial Network (GAN). In adversarial learning, the generator network, which is used for regularization, and a binary classifier network, which decides if an input image is a natural high-resolution image, are trained together. The purpose of the generator network is to achieve that the network output image is classified by the classifier network as a real image. In the meantime, the classifier network aims to make a distinction between the real image and the generator network output image. Therefore, the generator network represents an artefact/noise suppressing deep network that attempts to manipulate the classifier, i.e., aims to correct the distorted/noisy image and make it classified as a real image. In the training of both architectures, the adversarial loss function is used.
A deep network architecture which can be easily adapted to different inverse problems, which is trained by using original image and distorted observations and learns the physical model parameters of the problem. Aiming to estimate the inverse problem model, this deep architecture is designed as a regression network. The existing classifier network architectures can be converted to a regression network for this purpose or a deep network architecture specific to this problem can be used as well. The purpose of this deep network which takes the observation data and original image as input is to learn the physical model of the problem independent of the noise type and level. In addition, in order for this deep architecture to be used in different inverse problems, a multi-tasking deep architecture that learns the type (motion, focus blur, etc.) and parameter values of the problem model together was developed.
A deep architecture that learns the reconstruction (model inversion) from distorted image to original image. The purpose of this network is to reduce the computational complexity of iterative reconstruction process. By giving the distorted image and inverse problem model to the deep network as input, it is aimed for the deep network to learn a general reconstruction operation.
For the training of this network, there is no need for visual data; a random noise data is created and the reconstruction process is learned by training the deep network with different problem models. In the training of the network, total square error is used as the loss function.

These separately trained three deep networks are brought together and a general architecture for the solution of blind inverse problems is created. Then, use of this general architecture successfully for the solution of different inverse problems in images and videos (blind deblurring, single image super-resolution and video super-resolution) is aimed. Problem-specific aims are listed in the following:
The developed general architecture can be used in blind deblurring problems for the solution of various blur problems such as, motion blur and focus blur. Spatially varying blur problems can also be solved with the developed architecture.
The general architecture can be adapted to the solution of single image super-resolution problem. It is possible to render super-resolution at different scale factors with a single deep architecture.
The general architecture can be adapted to the solution of video super-resolution problem. Estimating a separate illumination/blur model for each neighboring frame in the video; thereby providing a better matching with the middle frame, and decreasing the artefacts in the synthesized high-resolution frame is possible.

In this invention, general deep learning approaches and deep neural network architectures that can be used for the solution of various inverse problems in image processing were developed. It is aimed for the trained deep network architecture to be as independent as possible from the inverse problem model and parameters or to be adaptable to the related problem with a quick fine-tuning. Additionally, it is aimed for this deep network to be used in the solution of blind problems where the distortion model is variable or unknown. Fine tuning means adapting the model parameters to the related problems by applying a short period of training with the transfer learning method on a data set belonging to the particular problem. In transfer learning, the training begins with the original network parameter values and the parameter values are adapted/optimized iteratively, in a way to reduce the total loss value for the data set. The developed deep architecture is composed of three sub-blocks: The deep network estimating the distortion model, the deep network performing the reconstruction, and the deep network performing the regularization. These three architectures are first separately trained as independent from each other. Then, the three architectures are trained end-to-end within the iterative optimization structure to increase the estimation performance. In addition, the architectures are fine-tuned for every inverse problem (deblurring, image/video super-resolution) aimed to be solved and for every data set.

The steps applied:
1. Separate training of the deep network architectures: For the P network performing the regularization step, adversarial learning techniques are used. The Q deep architecture aiming to estimate the inverse problem model is designed as a regression network. The purpose of the D network is to reduce the computational complexity of the iterative reconstruction process and it is trained to learn a general reconstruction operation.
2. Joint iterative end-to-end training of deep network architectures

The separately trained P, Q and D deep architectures are combined as in FIG. 1 and the entire system is trained end-to-end. Thereby, the architectures which have been trained with different targets and loss functions are fine tuned in a way to reduce the image estimation error to minimum within the structure given in FIG. 1. It is aimed for the solution architecture resulting from these works to be independent of the inverse problem model and to be applied to blind problems. For this reason, caution is taken for the training data set used to be a large data set comprising different inverse problems and distortion models.
3. The trained general deep network architecture is adapted to the related problem by using a problem-specific training data set for each inverse problem desired to be solved by the transfer learning approach and quick fine-tuning.

A method for the model-independent solution of inverse problems with deep learning in image/video processing, characterized in that it comprises the steps of;
i. Taking the input image through a shock filter (Cho, S., Lee, S. 2009. “Fast Motion Deblurring”, ACM Trans. Graph., 28(5), 145:1-145:8.) and obtaining the first estimate of the distortion model, and obtaining the first estimate of the output image by applying reconstruction to the input image based on the estimated model,
ii. Obtaining pre-regularization intermediate output image by putting the input image, model estimate and output image estimate to the deep network (D) which performs the reconstruction,
iii. Updating the output image estimate by putting the intermediate output image to the deep network (P) that performs the regularization,
iv. Updating the distortion model estimate by putting the input image and output image estimate to the deep network (Q) which estimates the distortion model,
v. returning to step ii. and repeating all the steps with the updated output image and updated distortion model for a particular number of iterations.

1. A method for the model-independent solution of inverse problems with deep learning in image/video processing, the method comprising the steps of:
i. obtaining a first estimate of an output image by taking an input image through a shock filter, and obtaining a first estimate of the output image by applying reconstruction to the input image based on an estimated model;
ii. obtaining a pre-regularization intermediate output image by putting the input image, model estimate and output image estimate to a deep network (D) which performs the reconstruction;
iii. updating the output image estimate by putting the intermediate output image to a deep network (P) that performs the regularization;
iv. updating a distortion model estimate by putting the input image and output image estimate to a deep network (Q) which estimates the distortion model; and
v. returning to step ii. and repeating all the steps with the updated output image and updated distortion model for a particular number of iterations.
